(19) United States
(12) Patent Application Publication
(10) Pub. No.: US 2015/0321589 A1
(43) Pub. Date: Nov. 12, 2015

(54) SEAT DEVICE

(71) Applicant: TS TECH CO., LTD., Saitama (JP)

(72) Inventors: Hirotaka TAKEI, Shioya-gun (JP); So IWAKATA, Shioya-gun (JP); Daisuke KITAGAWA, Shioya-gun (JP)

(73) Assignee: TS TECH CO., LTD., Saitama (JP)

(21) Appl. No.: 14/443,799

(22) PCT Filed: Nov. 18, 2013
(86) PCT No.: PCT/JP2013/081040

§ 371 Date: May 19, 2015

(30) Foreign Application Priority Data
Nov. 19, 2012 (JP) 2012-253514
Nov. 19, 2012 (JP) 2012-253515

(51) Int. Cl. B60N 2/58; B60N 2/68

(52) U.S. Cl. CPC B60N 2/5816; B60N 2/68

(57) ABSTRACT

A seat device includes a seat back frame; right and left cushion side frames respectively disposed at right and left sides of a lower part of the seat back frame; a cover fixing member for fixing a cover covering a surface of a cushion pad(s) attached to one of the right and left cushion side frames. The cover fixing member extends downward from the cushion side frame and extends in the front-rear direction. The seat device further includes a cover fastener for fastening the cover to the cover fixing member. The cover fastener includes an engaging portion engaging with the cover fixing member and a main fastener integrally formed with the engaging portion. The main fastener extends in the front-rear direction. The cushion side frame is fitted with a rotation regulating member for regulating the rotation of the cover fastener about the engaging portion.

### TECHNICAL FIELD

The present invention relates to a seat device and particularly to a seat device to be mounted in a vehicle.

### BACKGROUND ART

A conventional seat device for a vehicle or other use includes a seat back frame and right and left cushion side frames disposed at right and left sides, respectively, of a lower part of the seat back frame. A cushion pad(s) is disposed between the cushion side frames and on the outsides of the cushion side frames. A cover such as a trim cover is attached to cover upper and lateral faces of the cushion pad. It is known that a cushion side frame is provided with a trim wire or another cover fixing member extending downward to fasten a cover, as disclosed in Patent Document 1. In Patent Document 1, the cover is fastened to the cover fixing member with a hog ring, for example. In recent years, it also has been known that a cover is attached to a cover fixing member with a cover fastener.

### PRIOR ART DOCUMENT

### Patent Document

Patent Document 1: Japanese Utility Model Laid-Open Publication No. H5-1344

### SUMMARY OF INVENTION

### Problem to be Solved by the Invention

If a person sits on a cover attached to a cover fixing member with a fastener member, the cover is pulled and the pulled cover can cause the cover fastener to move. Such a movement of the cover fastener will lead to undesirable detachment of the cover fastener from the cover fixing member.

It is an object of the present invention to provide a seat device including a cover fastener with high fastening characteristics to suppress the movement of the cover fastener even if a person sits on the seat device.

### Means for Solving the Problem

To solve the above problem, the invention of claim 1 is a seat device comprising: a seat back frame; right and left cushion side frames respectively disposed at right and left sides of a lower part of the seat back frame; a cover fixing member for fixing a cover covering a surface of a cushion pad attached to one of the right and the left cushion side frames, the cover fixing member extending downward from the one of the right and left cushion side frames and extending in a front-rear direction of the seat device; and a cover fastener for fastening the cover to the cover fixing member, the cover fastener comprising: an engaging portion engaging with the cover fixing member; and a main fastener integrally formed with the engaging portion and extending in the front-rear direction of the seat device, and wherein the one of the right and left cushion side frames comprises a rotation regulating member for regulating a rotation of the cover fastener about the engaging portion.

The invention of claim 2 is the seat device according to claim 1, wherein the rotation regulating member is a reinforcing member placed between the one of the right and left cushion side frames and the cover fixing member, the reinforcing member laterally brought into contact with the main fastener of the cover fastener.

The invention of claim 3 is the seat device according to claim 1 or 2, further comprising right and left guide rails for guiding the right and the left cushion side frames in the front-rear direction of the seat device, wherein the rotation regulating member is disposed outside one of the right and left guide rails in a widthwise direction of the seat device and is disposed on a front end of the one of the right and left cushion side frames, and the cover attached near to an front side of the one of right and left cushion side frames is fastened to the rotation regulating member.

The invention of claim 4 is the seat device according to claim 3, wherein the rotation regulating member is disposed at a location where a vertical distance between the one of the right and left cushion side frames and the cover fixing member is the largest.

The invention of claim 5 is the seat device according to any one of claims 2 to 4, further comprising a second cover fastener through which the cover is fastened to the rotation regulating member, wherein the rotation regulating member has a bent segment at a center thereof, and the second cover fastener has a bent portion corresponding to the bent segment of the rotation regulating member.

The invention of claim 6 is the seat device according to claim 5, wherein the bent segment of the rotation regulating member convexly curves in the laterally outward direction of the seat device, and the second cover fastener has a cutout in the bent portion corresponding to the bent segment.

The invention of claim 7 is the seat device according to any one of claims 3 to 6, comprising: right and left support frames slidably supported respectively by the right and the left guide rails, the right and the left support frames respectively supporting the right and the left cushion side frames; and

a linkage segment including first and second ends, the first end being rotatably mounted to an inner side of the one of the right and left cushion side frames, and the second end being rotatably mounted to an outer side of one of the right and left support frames via a rotary shaft, so as to move up and down the right and left cushion side frames with respect to the right and left support frames, wherein the rotation regulating member is separated from the rotary shaft at the second end of the linkage segment.

The invention of claim 8 is the seat device according to claim 1, comprising: right and left support frames respectively supporting the right and left cushion side frames; and a linkage segment including first and second ends, the first end being rotatably mounted to an inner side of the one of the right and left cushion side frames, and the second end being rotatably mounted to an outer side of one of the right and left support frames via a rotary shaft, so as to move up and down the right and the left cushion side frames with respect to the right and left support frames,

wherein the cover fixing member extends downward from the one of the right and left cushion side frames to a position laterally overlapping with the linkage segment so as to fix the cover, and the cover fixing member has a detour segment that does not axially overlap with the rotary shaft at the second end of the linkage segment.

The invention of claim 9 is the seat device according to claim 8, wherein the detour segment does not axially overlap with the rotary shaft at the second end of the linkage segment when the right and left cushion side frames are located at the uppermost level with respect to the right and left support frames.

The invention of claim 10 is the seat device according to claim 8 or 9, wherein the detour segment has a humped shape convex upward.

The invention of claim 11 is the seat device according to claim 10, wherein the detour segment has a chevron shape.

The invention of claim 12 is the seat device according to any one of claims 8 to 11, comprising: a cover fastener for fastening the cover to the cover fixing member, wherein the cover fastener comprises: an engaging portion engaging with the cover fixing member; and a main fastener integrally formed with the engaging portion, the main fastener extending in the front-rear direction of the seat device and facing the detour segment.

The invention of claim 13 is the seat device according to claim 12, wherein the main fastener is in contact with the detour segment in advance.

The invention of claim 14 is the seat device according to claim 12 or 13, wherein the engaging portion has a cutout at a portion thereof corresponding to the detour segment so as to suppress contact with the detour segment.

The invention of claim 15 is the seat device according to any one of claims 12 to 14, wherein the linkage segment is provided at each of front and rear of the one of the right and left cushion side frames, and the cover fixing member has detour segments facing front and rear linkage segments, respectively, and a portion between the detour segments has a linear shape.

The invention of claim 16 is the seat device according to claim 15, wherein the cover fastener is provided as a single continuous member for a plurality of the detour segments.

### Effects of Invention

According to the invention of claim 1, the rotation regulating member regulates the rotation of the cover fastener about the engaging portion. This configuration can regulate the rotation of the cover fastener even if a person sits on the seat device to pull the cover, suppress undesirable detachment of the cover fastener from the cover fixing member, and thus improves the fastening performance of the cover fastener.

According to the invention of claim 2, the rotation regulating member is placed between the cushion side frame and the cover fixing member. The rotation regulating member reinforces the cover fixing member to increase the strength of the cover fixing member.

According to the invention of claim 3, the rotation regulating member is disposed outside one of the right and left guide rails in the widthwise direction of the seat device and is disposed on the front end of the cushion side frame. The cover attached near to the front side of the one, of right and left cushion side frames is fastened to the rotation regulating member. This configuration ensures that the cover is separated from the guide rail and can suppress interference of the cover with the guide rail.

According to the invention of claim 4, the rotation regulating member is disposed at a location where the vertical distance (separation) between the cushion side frame and the cover fixing member is the largest. In other words, the rotation regulating member is disposed at a location where the cover can most readily enter the separation and interfere with the guide rail. While the seat device is being slid, the rotation regulating member gives clearance between the cover and the guide rail. Thus, the cover is suppressed to interfere with the guide rail.

According to the invention of claim 5, the second cover fastener has a bent portion corresponding to the bent segment of the rotation regulating member. The bent portion of the second cover fastener suppresses the rotation of the second cover fastener about the rotation regulating member.

According to the invention of claim 6, the bent segment of the rotation regulating member convexly curves in the laterally outward direction. Thus, the cover is separated from the guide rail at a larger distance and interference between them can be more reliably suppressed. The second cover fastener also has the cutout in the bent portion corresponding to the bent segment of the rotation regulating member so as to expose the bent segment of the rotation regulating member. In other words, the cutout exempts the second cover fastener from engaging with the bent segment of the rotation regulating member. The cutout contributes to a simpler configuration of the second cover fastener than that of a second cover fastener engaging with the bent segment of the rotation regulating member. In the case of a second cover fastener engaging with the bent segment of the rotation regulating member, the second cover fastener should have a bent portion corresponding to the bent segment of the rotation regulating member. Stress can be concentrated to the bent portion of the second cover fastener at engagement. A section where stress is concentrated is susceptible to detachment from the rotation regulating member. The cutout can advantageously lower a concentrated stress, leading to an improvement in the stability of the second cover fastener.

According to the invention of claim 7, the rotation regulating member is separated from the rotary shaft at the second end of the linkage segment. This configuration leaves a certain amount of clearance at the sides of the rotary shaft at the second end of the linkage segment. Thus, the rotation regulating member does not interfere with mounting of the linkage segment on the support frame. This facilitates the assembly of the component.

According to the invention of claim 8, the cover fixing member for fixing the cover covering the cushion pad has the detour segment that does not axially overlap with the rotary shaft on the second end of the linkage segment. This configuration leaves a certain amount of clearance at the sides of the rotary shaft at the second end of the linkage segment. Thus, the cover fixing member does not interfere with mounting of the linkage segment on the support frame. This facilitates the assembly of the component.

When the right and left cushion side frames are located at the lowermost level after the tilting of the linkage segment, the one of the right and left cushion side frames may hide the rotary shaft at the second end of the linkage segment. Under such a condition, the cushion side frame hides the sides of the rotary shaft regardless of the detour segment of the cover fixing member. This counteracts the improvement in assembly workability.

When the right and left cushion side frames are located at the uppermost level after the erection of the linkage segment, the rotary shaft on the second end of the linkage segment is exposed. According to the invention of claim 9, the detour segment that does not axially overlap with the rotary shaft at the second end of the linkage segment when the right and left cushion side frames are located at the uppermost level with respect to the right and left support frames suppresses that the cushion side frame hides the sides of the rotary shaft. Moreover, the detour segment defines a clearance around it. This further facilitates the assembly of the component.

According to the invention of claim 10, the detour segment has a humped shape convex upward. This configuration provides a smaller increase in width than the detour segment curving convexly in the widthwise direction.

According to the invention of claim 11, the detour segment having a chevron shape makes it possible for the detour segment to be formed with a small number of bent points. This configuration increases the assembly efficiency.

According to the invention of claim 12, the main fastener of the cover fastener faces the detour segment. Thus, force for triggering the cover fastener to rotate about the engaging portion only causes the main fastener to come into contact with the detour segment, resulting in no further rotation of the cover fastener and non-detachment of the cover fastener from the cover fixing member.

If a gap is present between the main fastener and the detour segment, noise can be possibly produced each time the main fastener is brought into contact with the detour segment by rotation of the cover fastener. According to the invention of claim 13, the main fastener, however, has already come into contact with the detour segment. This configuration can prevent noise which is otherwise produced when a separated main fastener is brought into contact with the detour segment.

According to the invention of claim 14, the engaging portion has a cutout at a portion thereof corresponding to the detour segment so as to suppress contact with the detour segment. This configuration can ensure suppression of the worsening of engagement caused by interference between the engaging portion and the detour segment.

For example, if a single detour segment is provided for a plurality of linkage segments, the detour segment will inevitably has an increased size. Preferably, the engaging portion of the cover fastener should engage with portions other than the detour segment. Thus, a large detour segment results in a reduced proportion of the engaging portion. For this reason, according to the invention of claim 15, the portion between the detour segments corresponding to the front and rear linkage segments has a linear shape. The linear portion can also beheld with the engaging portion of the cover fastener. This improves the stability of the cover fastener after installation.

According to the invention of claim 16, the cover fastener is provided as a single continuous member for the plurality of detour segments. This enhances assembly efficiency compared to separate cover fasteners that are provided for the detour segments.

### BRIEF DESCRIPTION OF DRAWINGS

FIG. 1 is a perspective view of essential components of a seat device according to the present embodiment.

FIG. 2 is a cross-sectional view of a portion of the seat device shown in FIG. 1.

FIG. 3 is a schematic side view of a trim wire and a fastener member shown in FIG. 2.

FIG. 4 is a perspective view seen from an outer side illustrating a positional relationship between a guide rail and a reinforcing member of the seat device in FIG. 1.

FIG. 5 is a perspective view seen from an inner side illustrating the guide rail and the reinforcing member in FIG. 4.

FIG. 6 is a cross-sectional view taken from line VI-VI of FIG. 5.

FIG. 7 is a side view seen from an inner side of an elevating mechanism on a side near to a right cushion side frame at the lowermost level according to the embodiment.

FIG. 8 is a side view seen from the inner side of the elevating mechanism on the side near to the right cushion side frame at the uppermost level according to the embodiment.

FIG. 9 is a side view seen from the outer side of the right cushion side frame according to the embodiment.

FIG. 10 is an enlarged side view seen from the outer side of the rear end of the right cushion side frame according to the embodiment.

FIG. 11 is an enlarged side view of FIG. 10 to which a bracket drawn with a phantom line is added.

FIG. 12 is an enlarged rear view of the rear end of the cushion side frame of FIG. 10.

FIG. 13 is a perspective view seen from the inner side of a recess according to the embodiment.

FIG. 14 is a perspective view seen from the outer side of the recess of FIG. 13.

### DESCRIPTION OF EMBODIMENTS

An embodiment of the present invention will now be described with reference to the attached drawings. The embodiment described below features various technically preferred configurations for accomplishing the present invention. The scope of the present invention, however, should not be limited to the embodiment shown below and examples depicted in the drawings.

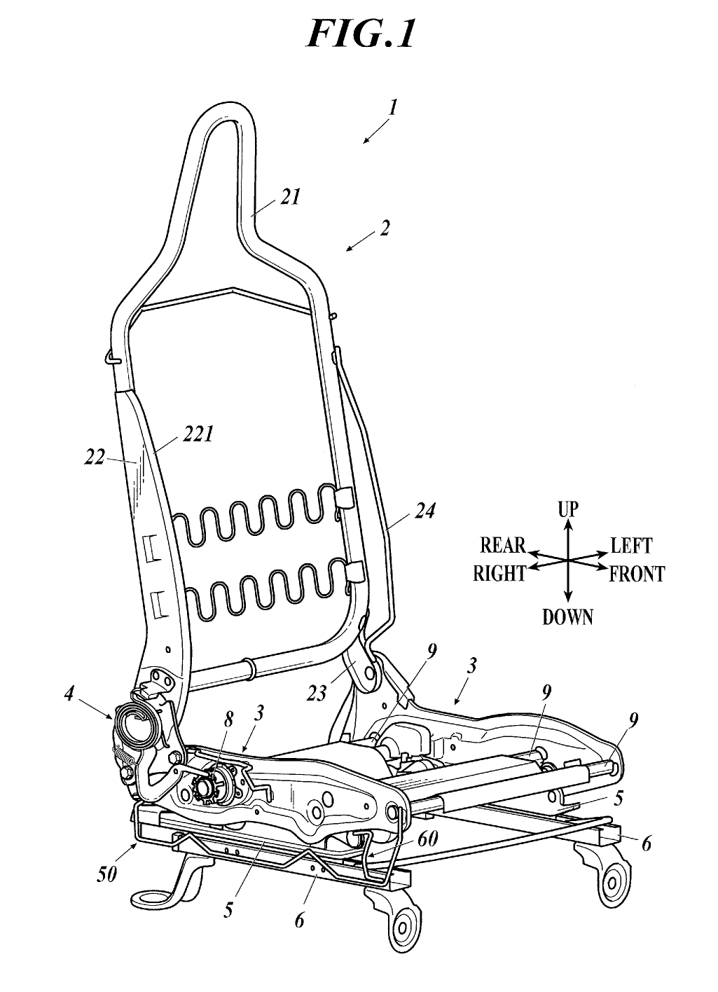

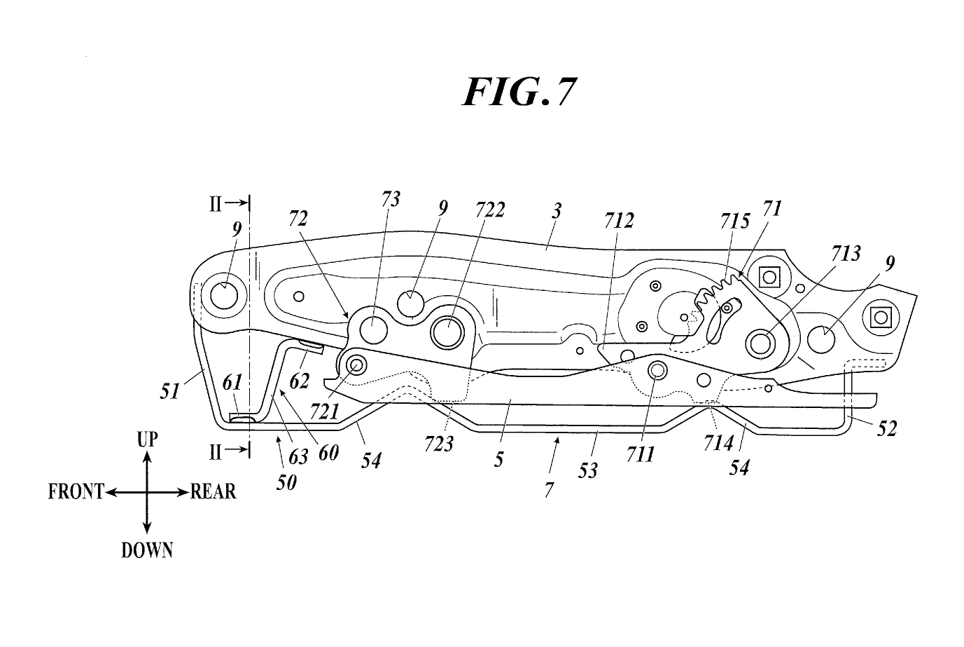

FIG. 1 is a perspective view of essential components of a seat device according to the present embodiment. With reference to FIG. 1, a seat device 1 includes: a seat back frame 2; a pair of right and left cushion side frames 3 respectively disposed at right and left lower parts of the seat back frame 2; a reclining mechanism 4 for tilting the seat back frame 2 toward or away from the cushion side frames 3; a pair of right and left support frames 5 supporting the respective right and left cushion side frames 3; a pair of right and left guide rails 6 which slidably support the respective support frames 5 to guide the support frames 5 in an front-rear direction; an elevating mechanism 7 (refer to FIG. 7) to adjust the seat height through upward or downward movement of the cushion side frames 3 relative to the support frames 5; an actuation transmitter 8 (a height brake) for activating the elevating mechanism 7.

In the description below, the “inside”, “internal” and “inner” refer to the space defined by the right and left cushion side frames 3, whereas the “outside”, “external” and “outer” refer to the space surrounding the right and left cushion side frames 3, unless otherwise specified.

The seat back frame 2 includes a seat back main segment 21 composed of a pipe and having a substantially convex shape in a front view; a side frame segment 22 attached to a right portion of the seat back main segment 21 and extending vertically; a hinge 23 attached to a lower left corner of the seat back main segment 21; and a side wire 24 extending between a left portion of the seat back main segment 21 and the hinge 23.

The side frame segment 22 is composed of a metal plate. The side frame segment 22 has a flange 221 extending in a vertical direction along the front and rear edges of the side frame segment 22. The lower end of the side frame segment 22 is linked to the right cushion side frame 3 via the reclining mechanism 4.

The hinge 23 is rotatably supported on the rear end of the left cushion side frame 3.

The side wire 24 is composed of a metal rod. The side wire 24 extends between the left portion of the seat back main segment 21 and the hinge 23 so as to have a shape conforming to the front external shape of the side frame segment 22.

The side wire 24 has lower rigidity than that of the side frame segment 22. Thus, the seat back frame 2 is asymmetrical in rigidity between the right and left sides.

In the inner side of the right and left cushion side frames, three connecting members 9 are placed between the right and left cushion side frames 3 to connect these cushion side frames 3. Ends of a first one of the three connecting members 9 are fixed to the front ends of the cushion side frames 3. Ends of a second one of the connecting members 9 are fixed to the rear ends of the cushion side frames 3. Ends of a third one of the connecting members 9 are fixed to the middle regions of the cushion side frames 3.

Of the pair of right and left cushion side frames 3, the right cushion side frame 3 is provided with a trim wire 50 made from a metal rod. The trim wire 50 includes a front wire segment 51 extending downward from a front end of the right cushion side frame 3; a rear wire segment 52 extending downward from a rear end of the right cushion side frame 3; and a horizontal wire segment 53 extending in the front-rear direction from a lower end of the front wire segment 51 to a lower end of the rear wire segment 52. The horizontal wire segment 53 has two detour segments 54 each formed by being bent so as to have a humped shape protruding upward, such as a chevron shape. The detour segments 54 are formed at a predetermined distance.

A reinforcing member 60 made from a metal rod is placed between the front end of the horizontal wire segment 53 and the lower front of the right cushion side frame 3. The lower edge of the right cushion side frame 3 gradually rises from a region to which the third connecting member 9 is connected toward the front end of the right cushion side frame 3. Thus, the vertical distance between the right cushion side frame 3 and the trim wire 50 is the largest at the front end of the cushion side frame 3. The reinforcing member 60 is disposed at a location where the distance is the largest.

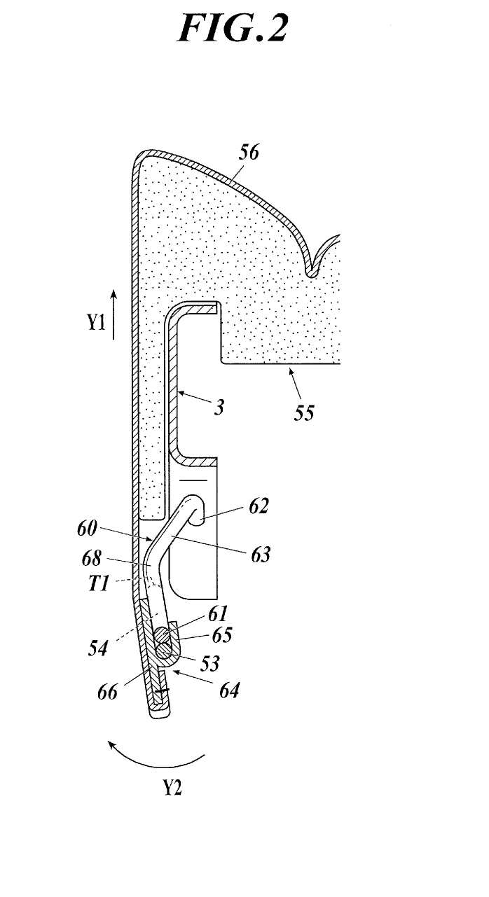

The reinforcing member 60 includes a first superposed segment 61 which is placed on the front end of the horizontal wire segment 53; a second superposed segment 62 which is placed on the lower front of the right cushion side frame 3; and a reinforcing main segment 63 extending in the vertical direction from the rear end of the first superposed segment 61 to the front end of the second superposed segment 62. The reinforcing main segment 63 has a bent segment 68 curved convexly toward the outside at the center thereof (refer to FIG. 2).

FIG. 2 is a cross-sectional view of a portion of the seat device 1 (a cross-sectional view taken from line II-II of FIG. 7). FIG. 2 also illustrates a cushion pad(s) 55 attached to the right and left cushion side frames 3 and a cover 56 covering the surface of the cushion pad(s) 55.

With reference to FIG. 2, the cushion pad (s) 55 is disposed between the right and left cushion side frames 3 and cover upper and outer faces of the cushion side frames 3. The cover 56 is attached to the surface of the cushion pad (s) 55. An end portion of the cover 56 protrudes from the cushion pad 55. A fastener member 64 is attached to a lower end of the end portion. Thus, the fastener member 64 serves as a cover fastener according to the present invention for fastening the cover 56 to the trim wire 50. Since the cover 56 is attached to the trim wire 50 via the fastener member 64, the trim wire 50 serves as a cover fixing member according to the present invention.

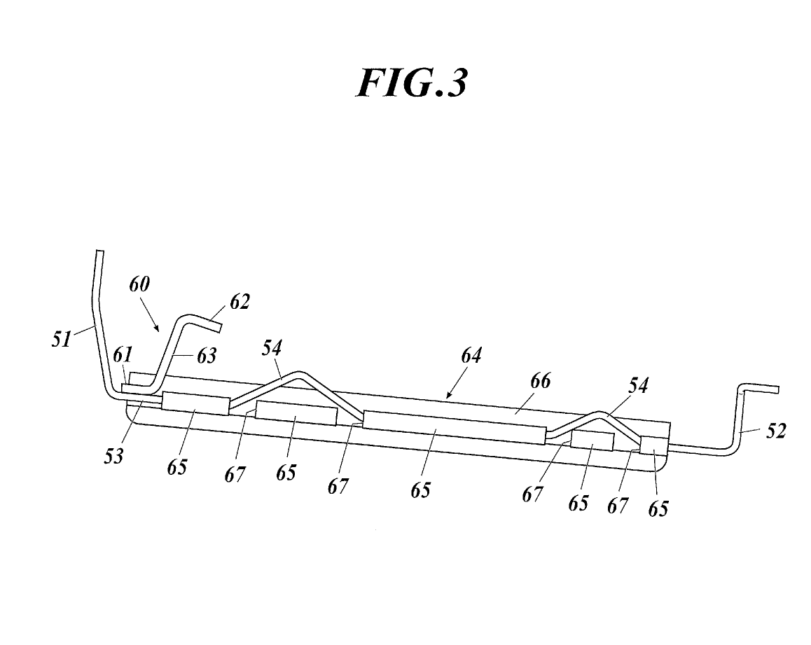

FIG. 3 is a schematic side view of the trim wire 50 and the fastener member 64. With reference to FIG. 3, the fastener member 64 includes engaging portions 65 engaging with the trim wire 50; and a main fastener 66 integrally formed with the engaging portions 65 and faces the horizontal wire segment 53 and the detour segments 54 while extending in the front-rear direction.

The main fastener 66 is substantially a plate member extending in the front-rear direction. The inner side face of the main fastener 66 is in contact with the detour segments 54. In FIG. 2, the peak of the detour segment 54 is denoted by a dotted line T1, and the outer side face of the detour segment 54 is in contact with the inner side face of the main fastener 66.

With reference to FIG. 3, the engaging portions 65 extend upward inside the main fastener 66. Each engaging portion 65 has a bent segment extending from the inner face of the main fastener 66 so as to have a curved shape convex downward. The horizontal wire segment 53 is accommodated between the engaging portion 65 and the main fastener 66 so as to engage therewith. An inner side of the engaging portion 65 has a hook (not shown). The hook engages with the horizontal wire segment 53 to hold the horizontal wire segment 53. The engaging portions 65 have cutouts 67 at portions facing the detour segments 54 such that the engaging portions 65 are suppressed contact with the detour segments 54. Thus, the single fastener member 64 is provided for a plurality of detour segments 54.

With reference to FIG. 2, the first superposed segment 61 and the main segment 63 of the reinforcing member 60 abut the main fastener 66 of the fastener member 64 from the inside. This configuration suppresses the rotation of the fastener member 64 about the engaging portion 65 (rotation in the direction of an arrow Y2 in FIG. 2). In other words, the reinforcing member 60 serves as a rotation regulating member according to the present invention.

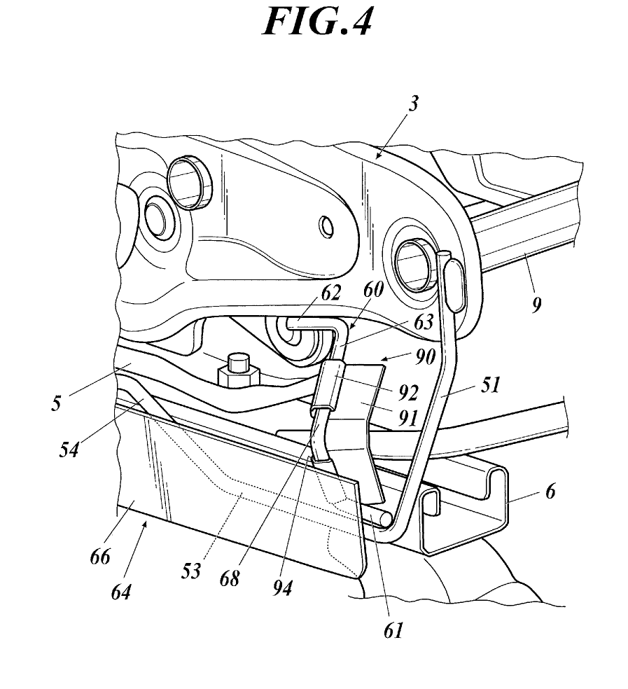

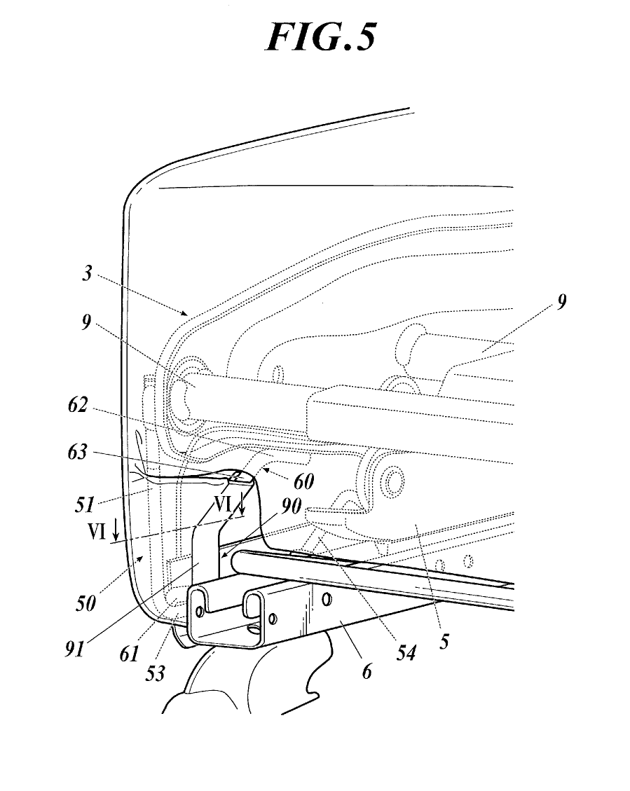

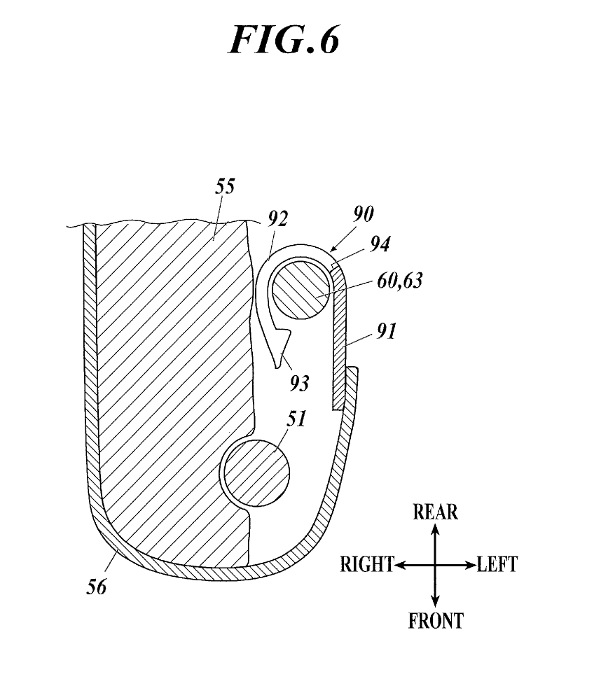

FIG. 4 is a perspective view seen form the outer side illustrating a positional relationship between the guide rail 6 and the reinforcing member 60. FIG. 5 is a perspective view seen from the inner side illustrating the same relationship. FIG. 6 is a cross-sectional view taken from line VI-VI of FIG. 5. FIG. 5 also illustrates the cushion pad(s) 55 and the cover 56.

With reference to FIGS. 4 and 5, the trim wire 50 and the reinforcing member 60 are disposed outside the guide rail 6 in a width direction. The cover 56, which is attached near to the front side of the right cushion side frame 3, is fastened to the main segment 63 of the reinforcing member 60 via a second fastener member 90. Specifically, with reference to FIG. 6, the cover 56 covers the side and front faces of the cushion pad (s) 55 at the lower front end of the right cushion side frame 3. The end of the cover 56 extends through the front face of the cushion pad(s) 55 toward the inside. The second fastener member 90 serving as a second cover fastener according to the present invention is attached to the end of the cover 56. The second fastener member 90 is fastened to the reinforcing member 60 such that the cover 56 covers the front wire segment 51 of the trim wire 50 and the inner front of the cushion pad(s) 55. Since the bent segment 68 of the reinforcing member 60 convexly curves toward the outside as described above, the cover 56 is separated from the guide rail 6 and interference of the cover 56 with the guide rail 6 is suppressed.

The second fastener member 90 will now be described. With reference to FIGS. 4 to 6, the second fastener member 90 includes a body 91 extending along the vertical direction over which the cover 56 is attached; and a locking segment 92 curving from the rear end of the body 91 toward the outside and extending forward. The body 91 is superposed on the main segment 63 of the reinforcing member. Thus, the body 91 is bent corresponding to the bent segment 68 of the main segment 63. The main segment 63 engages with a part extending along the locking segment 92 and the body 91. The locking segment 92 has a hook 93 at its end to lock the main segment 63. The locking segment 92 also has a cutout 94 corresponding to the bent segment 68 so as to expose the bent segment 68. The cutout 94 contributes to a simple configuration of the locking segment 92.

The elevating mechanism 7 is disposed between the right and left cushion side frames 3. The actuation transmitter 8 is disposed outside the right cushion side frame 3. The actuation transmitter 8 is engaged with the elevating mechanism 7 via the right cushion side frame 3.

FIG. 7 is a side view seen from an inner side of the elevating mechanism 7 on a side near to the right cushion side frame 3 located at the lowermost level.

The elevating mechanism 7 includes a pair of right and left rear linkage segments 71 and a pair of right and left front linkage segments 72. The rear and front linkage segments 71 and 72 on the left are connected to the inside of the left cushion side frame 3, whereas the rear and front linkage segments 71 and 72 on the right are connected to the inside of the right cushion side frame 3.

The right and left cushion side frames 3 are each fitted with the rear and front linkage segments 71 and 72 in a similar manner. The following description will focus on the relationship between the right cushion side frame 3 and the rear and the front linkage segments 71 and 72 on the right side, without description on the left cushion side frame 3.

A front end of the rear linkage segment 71 is rotatably supported on the outside of the support frame 5 via a first rear rotary shaft 711. The rear linkage segment 71 has a regulating portion 712 nearer to the front end thereof than the first rear rotary shaft 711. When the rear linkage segment 71 erects, the regulating portion 712 comes into contact with the support frame 5 to regulate the further rotation of the rear linkage segment 71. A rear end of the rotatable rear linkage segment 71 is rotatbly supported on the inside of the right cushion side frame 3 via a second rear rotary shaft 713. The second rear rotary shaft 713, which is composed of a pipe, is connected to the rear linkage segment 71 supported by the right cushion side frame 3. The rear linkage segment 71 includes a linear abutting edge 714 between the rotary shafts 711 and 713. The abutting edge 714 is in contact with the support frame 5 when the cushion side frame 3 is located at the lowermost level. The rear linkage segment 71 further includes a gear 715 which engages with the actuation transmitter 8 on a diagonally forward and upward side of the second rear rotary shaft 713.

A front end of the front linkage segment 72 is rotatably supported on the outside of the support frame 5 via a first front rotary shaft 721. The reinforcing member 60 is disposed at a position separated from the first front rotary shaft 721. A rear end of the front linkage segment 72 is rotatably supported on the inside of the cushion side frame 3 via a second front rotary shaft 722. The front linkage segment 72 has a linear abutting edge 723 below the second front rotary shaft 722. The abutting edge 723 is in contact with the support frame 5 when the cushion side frame 3 is located at the lowermost level. A pipe 73 is attached to the front linkage segment 72 supported by the right cushion side frame 3 on a diagonally backward and upward side of the first front rotary shaft 721 of the front linkage segment 72.

Thus, the rear and the front linkage segments 71 and 72, the support frame 5, and the cushion side frame 3 constitute a linkage mechanism. The right cushion side frame 3 is integrated with the left cushion side frame 3 through the three connecting members 9. The right rear linkage segment 71 is coupled to the left rear linkage segment 71 through the second rear rotary shaft 713. The right front linkage segment 72 is coupled to the left front linkage segment 72 through the pipe 73. As a result, the right and left linkages operate in the same fashion.

With reference to FIG. 7, when the right cushion side frame 3 is located at the lowermost level, the upper ends of the detour segments 54 of the trim wire 50 horizontally overlap with the support frame 5. At this time, the first rear rotary shaft 711 of the rear linkage segment 71 is hidden behind the right cushion side frame 3, when viewed from the right-hand side. On the other hand, the first front rotary shaft 721 of the front linkage segment 72 is not hidden by the right cushion side frame 3, when viewed from the right-hand side, although much clearance is not defined around the first front rotary shaft 721.

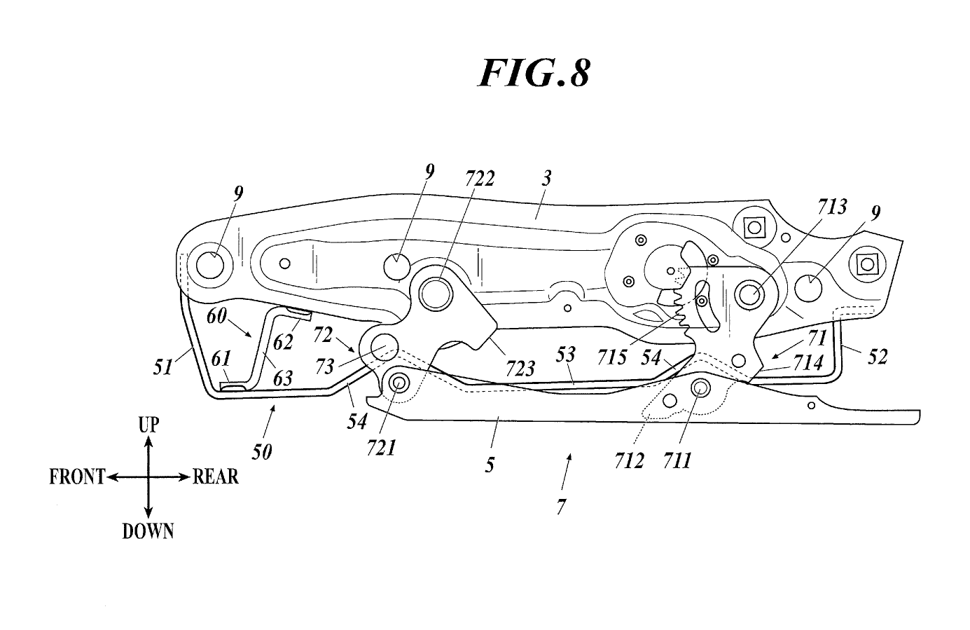

Actuation of the actuation transmitter 8 to erect the rear linkage segment 71 when the cushion side frame 3 is located at the lowermost level leads to the rotational erection of the rear linkage segment 71 about the first rear rotary shaft 711 and the rotational erection of the front linkage segment 72 about the first front rotary shaft 721. When the regulating portion 712 of the rear linkage segment 71 comes into contact with the support frame 5 through this rotation, the cushion side frame 3 does not further ascend (refer to FIG. 8).

FIG. 8 is a side view seen from the inner side of the elevating mechanism 7 on the side near to the right cushion side frame 3 located at the uppermost level. With reference to FIG. 8, while the right cushion side frame 3 rises to the uppermost position with respect to the support frame 5, the trim wire 50 moves diagonally forward and upward following the movement of the right cushion side frame 3. After the movement is completed, the first rear rotary shaft 711 of the rear linkage segment 71 and the first front rotary shaft 721 of the front linkage segment 72 are disposed in the respective inner regions of the two detour segments 54 of the trim wire 50. In other words, the first rear rotary shaft 711 and the first front rotary shaft 721 do not axially overlap with the detour segments 54. Thus, clearances are maintained outside the first rear rotary shaft 711 and the first front rotary shaft 721.

Actuation of the actuation transmitter 8 to tilt the rear linkage segment 71 when the cushion side frame 3 is located at the uppermost level leads to the rotational tilting of the rear linkage segment 71 about the first rear rotary shaft 711 and the rotational tilting of the front linkage segment 72 about the first front rotary shaft 721. When the abutting edges 714 of the rear linkage segments 71 and the abutting edge 723 of the front linkage segments 72 come into contact with the support frame 5 through this rotation, the cushion side frame 3 does not further descend (refer to FIG. 7).

During the ascent or descent, the cushion side frame 3 turns around both the second rear rotary shaft 713 and the second front rotary shaft 722 such that the cushion side frame 3 is kept horizontal.

The cushion side frames 3 will now be described in detail. The right and left cushion side frames 3 have substantially the same shapes. The right cushion side frame 3 differs from the left cushion side frame 3 only in that the right cushion side frame 3 is fitted with the actuation transmitter 8. Thus, the following description will focus on the right cushion side frame 3, without description on the left cushion side frame 3.

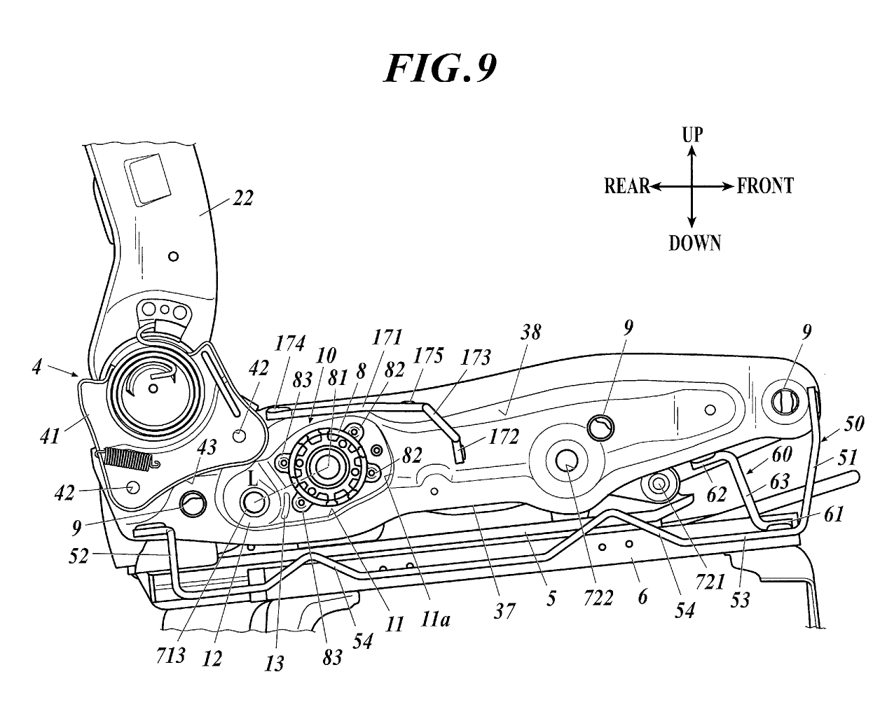

FIG. 9 is a side view seen from the outer side of the right cushion side frame 3. A bracket 41 for the reclining mechanism 4 is mounted on the rear end of the right cushion side frame 3. The bracket 41 rotatably supports the side frame 22 of the seat back frame 2.

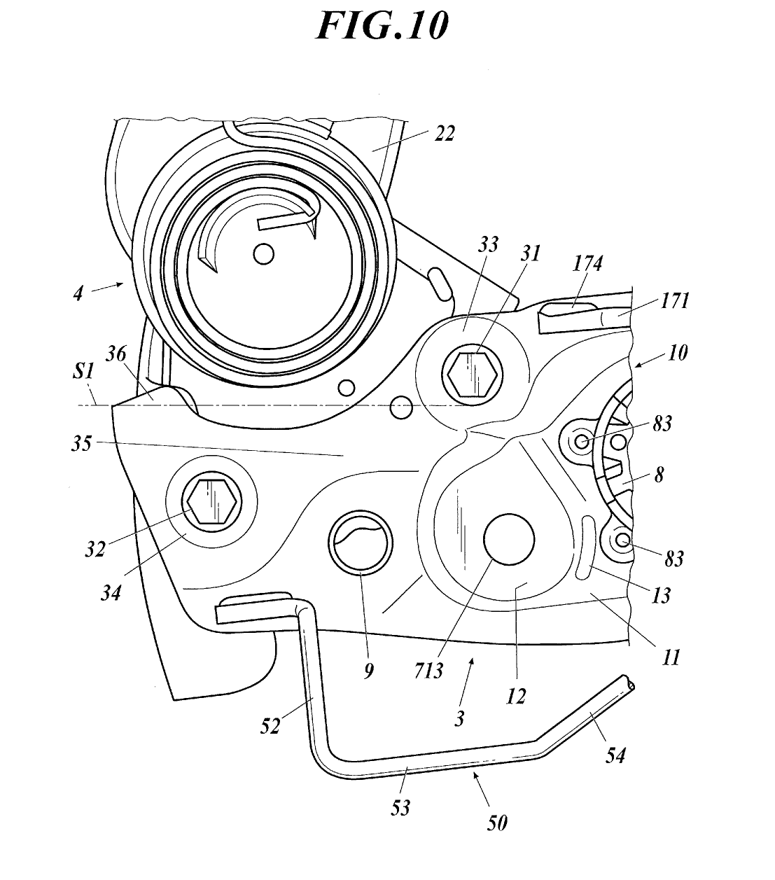

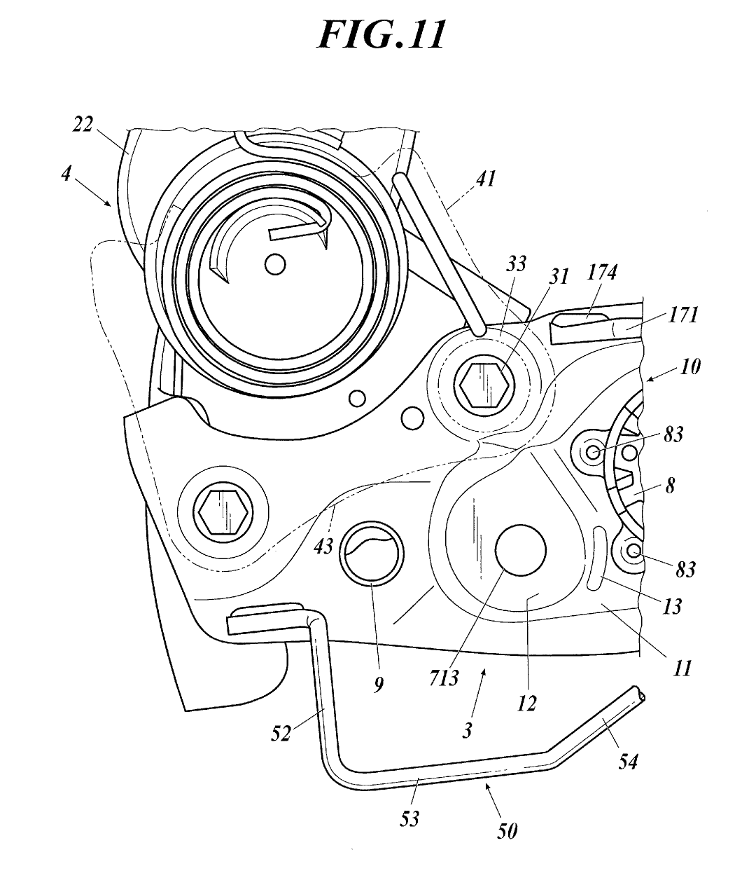

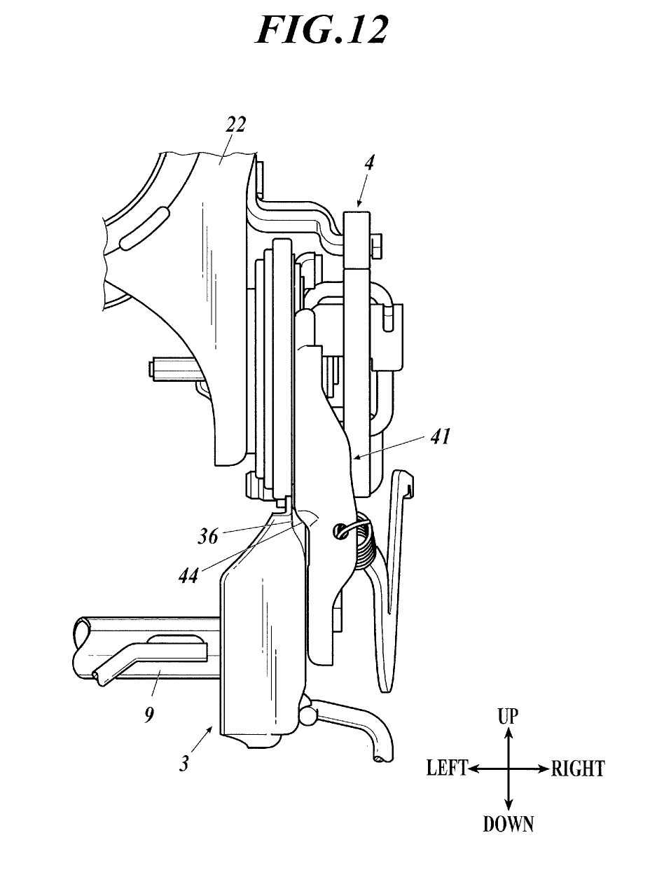

FIG. 10 is an enlarged side view seen from the outer side of the rear end of the cushion side frame 3. FIG. 11 is an enlarged side view of FIG. 10 to which the bracket drawn with a phantom line is added. FIG. 12 is an enlarged rear view of the rear end of the cushion side frame 3. With reference to FIGS. 10 to 12, a pair of bracket fasteners 31 and 32 is fitted on the rear end of the right cushion side frame 3. The bracket fasteners 31 and 32 secure the bracket 41 at front and back positions, respectively. The bracket fasteners 31 and 32 are bolts, for example. In the cushion side frame 3, attachment areas of the bracket fasteners 31 and 32 are formed as respective protrusions 33 and 34 protruding outward. The front protrusion 33 is located at a higher position than the rear protrusion 34. The protrusions 33 and 34 each have a threaded hole therein. A protrusion 35 protruding outward is also formed between the protrusions 33 and 34. Thus, the attachment areas of the bracket fasteners 31 and 32 are fitted on a series of the protrusions 33, 34, and 35.

The bracket 41 has through holes 42 at front and back positions of its lower section (refer to FIG. 9). When the through holes 42 are respectively positioned so as to face the protrusions 33 and 34, the bracket fasteners 31 and 32, respectively, are inserted into the through holes 42 and are screwed into the threaded holes of the protrusions 33 and 34, so that the bracket 41 is fixed to the cushion side frame 3. With reference to FIG. 12, the bracket 41 has a step 44 having a convex shape inward from its middle section to its upper part. A lower end 43 of the bracket 41 is formed so as to have a convex shape upward.

With reference to FIGS. 10 and 11, the cushion side frame 3 has a rear upper end 36 projecting higher than a lower end (a horizontal line S1 of FIG. 10) of the front bracket fastener 31 of the pair of the bracket fasteners 31 and 32. With reference to FIG. 12, the rear upper end 36 of the cushion side frame 3 is inclined inward along the step 44 of the bracket 41.

With reference to FIG. 9, the cushion side frame 3 has a narrowed portion 37 curving convexly upward at its bottom center.

The cushion side frame 3 has a reinforcing recess 38 recessed inward between the rearward of the front connecting member 9 and the forward of the rear connecting member 9. The reinforcing recess 38 provides rigidity in the cushion side frame 3. The center connecting member 9 is disposed in the reinforcing recess 38. The second front rotary shaft 722 is fitted diagonally backward and downward of the center connecting member 9 in the reinforcing recess 38.

The actuation transmitter 8 is disposed in the rear of the reinforcing recess 38 of the cushion side frame 3 and in front of the reclining mechanism 4. Specifically, a recess 10 for accommodating the actuation transmitter 8 is provided in the rear of the reinforcing recess 38. The actuation transmitter 8 is entirely surrounded by a step 11 defining the recess 10. With reference to FIGS. 10 and 11, the bracket fasteners 31 and 32 are disposed outside the recess 10. The front bracket fastener 31 of the bracket fasteners 31 and 32 is disposed at a position which vertically overlaps with the recess 10. A front part 11a of the step 11 defining the recess 10 is disposed rearward of the second front rotary shaft 722 and diagonally backward and upward of the narrowed portion 37.

The actuation transmitter 8 includes a pinion gear (not shown) engaging with the gear 715 of the rear linkage segment 71; a rotary shaft 81 connected to and integrated with the pinion gear; a lever (not shown) for turning the rotary shaft 81; and a brake mechanism (not shown) for holding the rotary shaft 81 in place when the lever is released. The lever is normally urged to a neutral position, i.e. an initial position before operations. Moving the lever upward or downward causes the rotary shaft 81 to rotate in a direction corresponding to the upward or downward movement of the lever. When the lever is released, only the lever is biased to be returned to the neutral position whereas the rotary shaft 81 is held at the rotated position by the break mechanism.

The actuation transmitter 8 is fitted with a pair of brake fixing portions 82 provided in front of the actuation transmitter 8 and a pair of brake fixing portions 83 provided behind the actuation transmitter 8. The brake fixing portions 82 and 83 are provided at predetermined intervals in a circumferential direction of the actuation transmitter 8. The brake fixing portions 82 and 83 are fixed to the cushion side frame 3.

The recess 10 has a bead 13 protruding inward therein such that the bead 13 is in lateral contact with the rear linkage segment 71.

The recess 10 also has a second step 12 rearward of the actuation transmitter 8. The second step 12 is disposed at a level different from that at which the actuation transmitter 8 is disposed. The second step 12 is located at an outer position than the actuation transmitter 8. The second rear rotary shaft 713 is fitted on the second step 12. The cushion side frame 3 is fitted with the rear connecting member 9 at its rear end, which is located rearward of the recess 10. In other words, the fitting positions of the actuation transmitter 8, the second rear rotary shaft 713, the rear connecting member 9, and the bracket fasteners 31 and 32 are disposed from inside toward outside in this order. The levels of the step 11, the second step 12, and the protrusions 33, 34 and 35 are formed such that the components fitted on them are disposed on different vertical planes.

The lower end 43 of the bracket 41 faces the rear connecting member 9. Since the lower end 43 has a shape curved upward, the bracket 41 avoids interfering with the rear connecting member 9.

The actuation transmitter 8 is disposed inside the recess 10 such that the pair of the rear brake fixing portions 83 are located forward of the front bracket fastener 31. Moreover, with reference to FIG. 9, the actuation transmitter 8 is disposed such that a line L joining the axes of the actuation transmitter 8 and the rear connecting member 9 extends between the pair of the rear brake fixing portions 83.

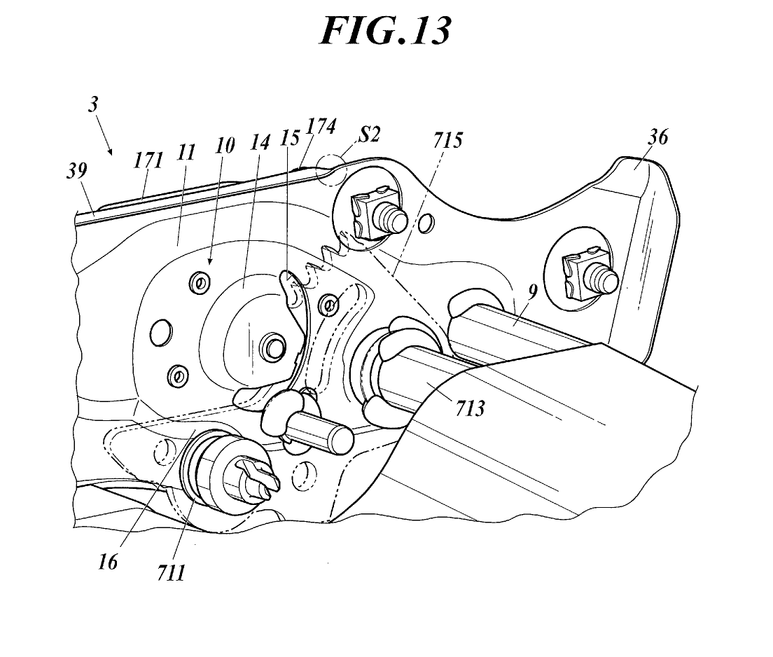

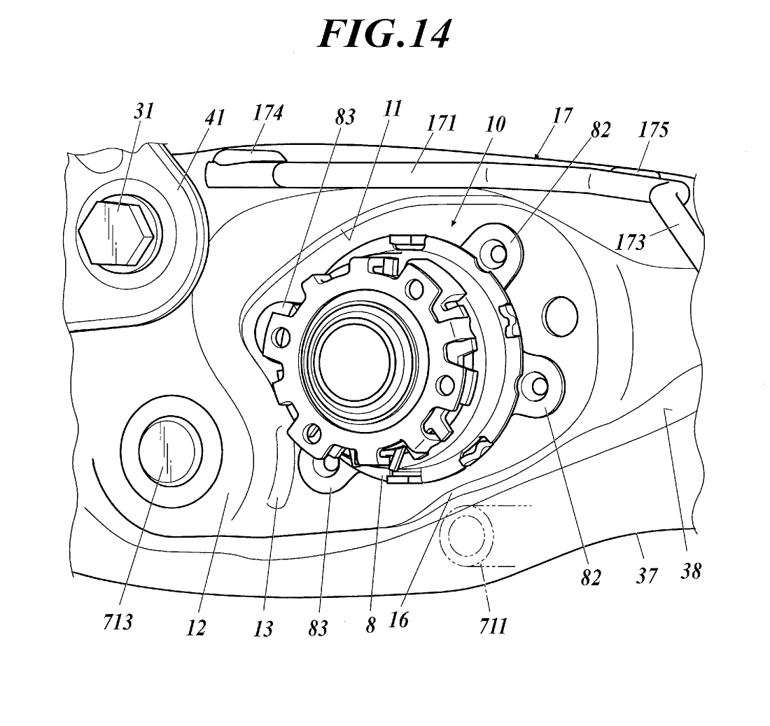

FIG. 13 is a perspective view seen from the inner side of the recess 10. FIG. 14 is a perspective view seen from the outer side of the recess 10.

With reference to FIG. 13, the recess 10 has a pinion gear recess 14 therein to accommodate the pinion gear of the actuation transmitter 8 further inside. The pinion gear recess 14 protrudes more inward than the recess 10. The pinion gear recess 14 has a slit 15 extending vertically in the rear to allow the pinion gear to engage with the gear 715 of the rear linkage segment 71.

With reference to FIGS. 13 and 14, the recess 10 is provided with a concave 16 so as to avoid contact of the approaching first rear rotary shaft 711 with the descending right cushion side frame 3. With reference to the internal view in FIG. 13, the concave 16 is a portion of the step 11 defining the recess 10, in which the portion curves concavely toward the center of the recess 10. With reference to the external view in FIG. 14, the concave 16 is a portion of the step 11, in which the portion curves convexly toward the center of the recess 10.

With reference to FIG. 9, the cushion side frame 3 is fitted with a wire 17 for supporting a seat belt or any other member to be supported (not shown). The wire 17 includes a long segment 171 extending in a front-rear direction, a short segment 172 extending vertically, and a bending segment 173 which connects the long segment 171 to the short segment 172. The short segment 172 is fixed to the reinforcing recess 38 by welding. A rear end of the long segment 171 is fixed to an immediate forward part of the bracket 41 in the upper edge of the cushion side frame 3 by welding. A front end of the long segment 171 is fixed to a forward part of the actuation transmitter 8 in the upper edge of the cushion side frame 3 by welding. The welded portions of the long segment 171 are referred to as rear and front fixing portions 174 and 175. The segment between the two fixing portions 174 and 175 faces the recess 10.

With reference to FIG. 13, the cushion side frame 3 has a flange 39 bent inward at its upper edge. The flange 39 extends from the front end of the cushion side frame 3 to the rear fixing portion 174 of the two fixing portions 174 and 175. The flange 39 has a cutout at its rear end near the rear fixing portion 174 (refer to a circle S2 of FIG. 13). The cushion pad covering the seat back frame 2 comes close to the cutout when the seat back frame 2 is reclined. The cutout suppresses contact of the flange 39 in vicinity of the cutout with the cushion pad.

According to the present embodiment described above, the reinforcing member 60 as a rotation regulating member prevents the rotation of the fastener member 64 about the engaging portion 65. Thus, a rotation of the fastener member 64 (in the direction of the arrow Y2 in FIG. 2) is suppressed even if a person sits on the seat device to pull the cover 56. As a result, undesirable detachment of the fastener member 64 from the trim wire 50 can be suppressed, leading to an improvement in the fastening performance of the fastener member 64.

Since the reinforcing member 60 is placed between the cushion side frame 3 and the trim wire 50, the reinforcing member 60 reinforces the trim wire 50 and increases the strength of the trim wire 50.

The reinforcing member 60 is disposed outside one of the right and left guide rails 6 in the widthwise direction and disposed on the front end of the cushion side frame 3. The cover 56 attached near to the front of the cushion side frame 3 is fastened to the reinforcing member 60. This configuration ensures that the cover 56 is separated from the guide rail 6 and interference thereof with the guide rail 6 is suppressed.

The reinforcing member 60 is disposed at a location where the vertical distance (separation) between the cushion side frame 3 and the trim wire 50 is the largest. In other words, the reinforcing member 60 is disposed at a location where the cover 56 can most readily enter the vertical separation and interfere with the guide rail 6. While the seat device is being slid, the reinforcing member 60 gives clearance between the cover 56 and the guide rail 6. Thus, the cover 56 is suppressed interference thereof with the guide rail 6.

Since the second fastener member 90 has a bent portion corresponding to the bent segment 68 of the reinforcing member 60, the bent portion of the second fastener member 90 suppresses the rotation of the second fastener member 90 about the reinforcing member 60.

Since the bent segment 68 of the reinforcing member 60 convexly curves toward the outside, the cover 56 can be separated from the guide rail 6 at a larger distance and interference between them can be more reliably suppressed. The second fastener member 90 also has the cutout 94 corresponding to the bent segment 68 so as to expose the bent segment 68. In other words, the cutout 94 exempts the second fastener member 90 from engaging with the bent segment 68. The cutout 94 contributes to a simpler configuration of the second fastener member 90 than that of a second fastener member 90 including a locking segment 92 entirely engaging with the bent segment 68. In the case of a locking segment 92 entirely engaging with the bent segment 68, the second fastener member 90 would have a bent portion corresponding to the bent segment 68. Unfortunately, stress would be concentrated on the bent portion of the second fastener member 90 at engagement. A section where stress is concentrated is susceptible to detachment from the reinforcing member 60. The cutout 94 can advantageously lower a concentrated stress, leading to an improvement in the stability of the second fastener member 90.

The reinforcing member 60 is separated from the first front rotary shaft 721 of the front linkage segment 72. This configuration leaves a certain amount of clearance at the sides of the first front rotary shaft 721 of the front linkage segment 72. Thus, the reinforcing member 60 does not interfere with mounting of the front linkage segment 72 to the support frame 5. This facilitates the assembly of the component.

The trim wire 50 for fixing the cover 56 which covers the surface of the cushion pad(s) 55, has the detour segments 54 which do not axially overlap with the first rear rotary shaft 711 of the rear linkage segment 71 and the first front rotary shaft 721 of the front linkage segment 72. This configuration leaves a certain amount of clearance at the sides of the first rear rotary shaft 711 of the rear linkage segment 71 and at the sides of the first front rotary shaft 721 of the front linkage segment 72. Thus, the trim wire 50 does not interfere with mounting of the rear and front linkage segments 71 and 72 to the support frame 5. This facilitates the assembly of the components.

When the right and left cushion side frames 3 are located at the lowermost level after the tilting of the rear and front linkage segments 71 and 72, the right and left cushion side frames 3 may hide the first rear rotary shafts 711 of the rear linkage segments 71 and the first front rotary shafts 721 of the front linkage segments 72. Under such a condition, the right and left cushion side frames 3 hide the sides of the rotary shafts 711 and 721 regardless of the detour segments 54 of the trim wire 50. This counteracts the improvement in assembly workability.

When the right and left cushion side frames 3 are located at the uppermost level after the erection of the rear and front linkage segments 71 and 72, the first rear rotary shafts 711 of the rear linkage segments 71 and the first front rotary shafts 721 of the front linkage segments 72 are exposed. In other words, the detour segments 54 that do not axially overlap with the first rear rotary shafts 711 of the rear linkage segments 71 and the first front rotary shafts 721 of the front linkage segments 72 when the right and left cushion side frames 3 are located at the uppermost level with respect to the right and left support frames 5 suppress that the right and left cushion side frames 3 hide the sides of the rotary shafts 711 and 721. Moreover, the detour segments 54 define a clearance therearound. This further facilitates the assembly of the components.

The detour segments 54 each having a humped shape convex upward provides a suppression of a size in a width direction than the detour segments 54 each curving convexly outward.

The detour segments 54 each having a chevron shape makes it possible for the detour segments 54 to be formed at a small number of bent points. This configuration increases the assembly efficiency.

When a person sits on the seat device 1, a tension is applied to the cover 56 in the direction of an arrow Y1 in FIG. 2. Since this tension also acts on the fastener member 64, force to rotate about the engaging portions 65 is applied to the fastener member 64 along the arrow Y2. The main fastener 66 of the fastener member 64, however, already faces the detour segments 54. Thus, force for triggering the fastener member 64 to rotate about the engaging portions 65 only causes the main fastener 66 to come into contact with the detour segments 54, resulting in no further rotation of the fastener member 64 and non-detachment of the fastener member 64 from the trim wire 50.

If a gap is present between the main fastener 66 and the detour segments 54, noise can be possibly produced each time the main fastener 66 is brought into contact with the detour segments 54 by rotation of the fastener member 64. The main fastener 66, however, has already come into contact with the detour segments 54. This configuration can suppress noise which is otherwise produced when a separated main fastener 66 is brought into contact with detour segments 54.

The engaging portions 65 have cutouts 67 at portions facing the detour segments 54 such that contact of the engaging portions 65 with the detour segments 54 is suppressed. Thus, this configuration can ensure to suppress worsening of the engagement of the engaging portions 65 caused by interference between the engaging portions 65 and the detour segments 54.

For example, if a single detour segment 54 is provided for linkage segments 71 and 72, the detour segment 54 will inevitably has an increased size. Preferably, the engaging portions 65 of the fastener member 64 should engage with portions other than the detour segments 54. Thus, a large detour segment 54 results in a reduced proportion of engaging portions 65. For this reason, the portion between the detour segments 54 corresponding to the rear and front linkage segments 71 and 72 has a linear shape. The linear portion can also be held by an engaging portion 65 of the fastener member 64. This improves the stability of the fastener member 64 after installation.

The continuous single fastener member 64 is provided for these detour segments 54. This enhances assembly efficiency compared to separate fastener members that are provided for the detour segments 54.

The scope of the present invention should not be limited to the embodiment described above, and should include various modifications and alterations without deviating from the gist of the present invention.

In the embodiment described above, the trim wire 50 is provided only for one cushion side frame 3 of the right and left cushion side frames 3, for example. The right and left cushion side frames 3 may be provided with respective trim wires 50.

### INDUSTRIAL APPLICABILITY

The present invention can be applied to a seat device to be mounted on a vehicle, for example.

### DESCRIPTION OF REFERENCE NUMERALS

1 seat device
2 seat back frame
3 cushion side frame
4 reclining mechanism
5 support frames
6 guide rails
7 elevating mechanism
8 actuation transmitter
9 connecting member
10 recess
11 step
11a front part
12 second step
13 bead
16 concave
17 wire
31, 32 bracket fastener
33, 34, 35 protrusion
36 rear upper end
37 narrowed portion
38 reinforcing recess
39 flange
41 bracket
43 lower end
44 step
50 trim wire (cover fixing member)
51 front wire segment
52 rear wire segment
53 horizontal wire segment
54 detour segment
55 cushion pad(s)
56 cover
60 reinforcing member (rotation regulating member)
64 fastener member (cover fastener)
65 engaging portion
66 main fastener
67 cutout
71 rear linkage segment
72 front linkage segment
73 pipe
81 rotary shaft
82, 83 brake fixing portion
90 second fastener member (second cover fastener)
91 body
92 locking segment
93 hooks
94 cutout
174, 175 fixing portion
711 first rear rotary shaft
713 second rear rotary shaft
721 first front rotary shaft
722 second front rotary shaft
L line

1. A seat device comprising:
a seat back frame;
right and left cushion side frames respectively disposed at right and left sides of a lower part of the seat back frame;
a cover fixing member for fixing a cover covering a surface of a cushion pad attached to one of the right and the left cushion side frames, the cover fixing member extending downward from the one of the right and left cushion side frames and extending in a front-rear direction of the seat device; and
a cover fastener for fastening the cover to the cover fixing member,
the cover fastener comprising:
an engaging portion engaging with the cover fixing member; and
a main fastener integrally formed with the engaging portion and extending in the front-rear direction of the seat device, and
wherein the one of the right and left cushion side frames comprises a rotation regulating member for regulating a rotation of the cover fastener about the engaging portion.

2. The seat device according to claim 1,
wherein the rotation regulating member is a reinforcing member placed between the one of the right and left cushion side frames and the cover fixing member, the reinforcing member laterally brought into contact with the main fastener of the cover fastener.

3. The seat device according to claim 1, further comprising right and left guide rails for guiding the right and the left cushion side frames in the front-rear direction of the seat device,
wherein the rotation regulating member is disposed outside one of the right and left guide rails in a widthwise direction of the seat device and is disposed on a front end of the one of the right and left cushion side frames, and
the cover attached near to an front side of the one of right and left cushion side frames is fastened to the rotation regulating member.

4. The seat device according to claim 3,
wherein the rotation regulating member is disposed at a location where a vertical distance between the one of the right and left cushion side frames and the cover fixing member is the largest.

5. The seat device according to claim 2, further comprising a second cover fastener through which the cover is fastened to the rotation regulating member, wherein
the rotation regulating member has a bent segment at a center thereof, and
the second cover fastener has a bent portion corresponding to the bent segment of the rotation regulating member.

6. The seat device according to claim 5, wherein
the bent segment of the rotation regulating member convexly curves in the laterally outward direction of the seat device, and
the second cover fastener has a cutout in the bent portion corresponding to the bent segment.

7. The seat device according to claim 3, comprising:
right and left support frames slidably supported respectively by the right and the left guide rails, the right and the left support frames respectively supporting the right and the left cushion side frames; and
a linkage segment including first and second ends, the first end being rotatably mounted to an inner side of the one of the right and left cushion side frames, and the second end being rotatably mounted to an outer side of one of the right and left support frames via a rotary shaft, so as to move up and down the right and left cushion side frames with respect to the right and left support frames,
wherein the rotation regulating member is separated from the rotary shaft at the second end of the linkage segment.

8. The seat device according to claim 1, comprising:
right and left support frames respectively supporting the right and left cushion side frames; and
a linkage segment including first and second ends, the first end being rotatably mounted to an inner side of the one of the right and left cushion side frames, and the second end being rotatably mounted to an outer side of one of the right and left support frames via a rotary shaft, so as to move up and down the right and the left cushion side frames with respect to the right and left support frames,
wherein the cover fixing member extends downward from the one of the right and left cushion side frames to a position laterally overlapping with the linkage segment so as to fix the cover, and
the cover fixing member has a detour segment that does not axially overlap with the rotary shaft at the second end of the linkage segment.

9. The seat device according to claim 8,
wherein the detour segment does not axially overlap with the rotary shaft at the second end of the linkage segment when the right and left cushion side frames are located at the uppermost level with respect to the right and left support frames.

10. The seat device according to claim 8,
wherein the detour segment has a humped shape convex upward.

11. The seat device according to claim 10,
wherein the detour segment has a chevron shape.

12. The seat device according to claim 8, comprising:
a cover fastener for fastening the cover to the cover fixing member, wherein
the cover fastener comprises:
an engaging portion engaging with the cover fixing member; and
a main fastener integrally formed with the engaging portion, the main fastener extending in the front-rear direction of the seat device and facing the detour segment.

13. The seat device according to claim 12,
wherein the main fastener is in contact with the detour segment in advance.

14. The seat device according to claim 12,
wherein the engaging portion has a cutout at a portion thereof corresponding to the detour segment so as to suppress contact with the detour segment.

15. The seat device according to claim 12,
wherein
the linkage segment is provided at each of front and rear of the one of the right and left cushion side frames, and
the cover fixing member has detour segments facing front and rear linkage segments, respectively, and a portion between the detour segments has a linear shape.

16. The seat device according to claim 15,
wherein the cover fastener is provided as a single continuous member for a plurality of the detour segments.
